(19) United States
(12) Patent Application Publication
(10) Pub. No.: US 2012/0091411 A1
(43) Pub. Date: Apr. 19, 2012

(54) SELF-RETRACTING HYDRAULIC JACK ASSEMBLY

(75) Inventors: Kevin J. Hansen, Eden Prairie, MN (US); Ted E. Ahrenholtz, Minnetonka, MN (US); Justin Paul Boortz, Waconia, MN (US)

(73) Assignee: BLUEROCK TECHNOLOGIES, INC., Minneapolis, MN (US)

(21) Appl. No.: 13/247,401

(22) Filed: Sep. 28, 2011

Related U.S. Application Data
(60) Provisional application No. 61/392,775, filed on Oct. 13, 2010.

(51) Int. Cl. B66F 3/25

(52) U.S. Cl. 254/93 R

(57) ABSTRACT

A self-retracting hydraulic jack assembly is provided which includes a leg retraction compression spring carried by the piston rod assembly encased within the hydraulic extension cylinder of the jack. The hydraulic jack has first and second telescoping tubular leg members that are extensible relative to one another in response to the introduction of hydraulic fluid through the piston rod assembly and into the extension cylinder of the jack assembly. A third freely adjustable drop-leg telescopes into the other legs of the jack assembly through a cam actuated pull-pin casting mounted thereto.

### BACKGROUND OF THE INVENTION

The present invention relates generally to the art of hydraulic jacks. More particularly, the present invention pertains to hydraulic jack assemblies of virtually any size and capacity with power extension and self-retracting capabilities.

It has heretofore been well known to utilize various mechanical and power-operated support jack assemblies to facilitate coupling and decoupling of a trailer apparatus from a towing vehicle, and as necessary, for supporting and leveling such a trailer. Such jack assemblies are typically mounted upon the tongue of a trailer and oftentimes require manual manipulation to raise and lower the trailer tongue. Manual screw jacks are generally commonplace with smaller load-bearing trailers, where manual rotation of a crank handle turns a vertical screw to effect the lifting and lowering of the trailer's tongue. Other hydraulically powered jacks incorporating a cylinder and ram system are oftentimes utilized for jacking heavier load-bearing trailers and the like. These devices usually comprise a series of telescoping upper and lower leg sections that slide relative to one another in response to a change in hydraulic pressure applied to the system. The hydraulic fluid may be pumped into the system through manual manipulation of a hand crank or via the use of a separate hydraulic power source.

While such prior lifting devices have been mildly successful in accomplishing their intended purpose, there are a number of deficiencies in their operation which make them less than satisfactory. For instance, some hydraulic jack assemblies incorporate a set of return springs connected between the telescoping legs to cause such legs to retract or collapse upon release of hydraulic pressure. These are typically tension springs, the ends of which are connected to the exterior of the telescoping legs. Such connections are subject to extensive wear and tear through repeated manipulation and long-term exposure to adverse weather conditions. Moreover, such devices are usually quite bulky, unsightly to look at, and offer limited options for mounting the jack due to design constraints.

Jacking devices equipped with a manual rotating crank or hand-operated pump handle are typically quite slow and tedious to operate, and suffer from similar mounting constraints due to the required operational design of the crank or pump, retraction springs, etc. One such exemplary hydraulic jack assembly can be found in U.S. Pat. No. 5,011,119, entitled: Conveniently Attached Hydraulic Trailer Jack. As noted, numerous working components of such manually operated devices are subject to premature aging and failure due to repeated manual manipulation and exposure to adverse weather conditions, and are bulky and unsightly in appearance. Particularly in situations where time is of the essence and large load-bearing capacities are required, such deficiencies in the prior art jacking devices can lead to significant and costly downtime, and possible catastrophic failure in the field.

It is therefore evident that there is a distinct need in the industry for a jacking device that is capable of full integration with existing trailer power/hydraulics; which minimizes premature failure due to repeated manual manipulation and/or exposure of critical working components to weather elements; and which is otherwise designed to prevent the wear and tear typically associated with conventional jacks. It is further desirable that such jack assembly be compact in design; provide maximum flexibility in mounting options to a trailer or the like; and be simple and pleasing in appearance.

### BRIEF SUMMARY OF THE INVENTION

One principal object of the present invention is therefore to overcome the deficiencies of prior art jacking devices by providing a self-retracting hydraulic jack assembly that enables full retraction of the jack's telescoping legs with no use of tension springs; reduces the overall number of required mechanical working components; and is more compact, reliable and durable functionally.

Another object of the present invention is to incorporate the critical working components of the jack assembly within a compact housing, thereby minimizing potential damage from exposure to the outside elements of nature and/or adverse weather conditions.

Still a further object of the present invention is to provide an improved hydraulic jack assembly of any desired size or capacity that incorporates such aforementioned design features and benefits, and is capable of full integration with existing trailer power/hydraulics.

The foregoing objects and others are achieved through use of the present invention, where a self-retracting hydraulic jack is provided which includes a leg retraction mechanism that is incorporated within and forms an integral part of the hydraulic extension cylinder of the jack. In general, the hydraulic jack is comprised of a plurality of telescoping tubular leg members that are extensible relative to one another in response to the introduction of hydraulic fluid into the extension cylinder. A first tubular leg member constitutes the outer structural body of the jack assembly, and is adapted for mounting in an upright position on the tongue of a trailer or the like. A second tubular leg member is telescopically received within the lower end of the first tubular leg and is hydraulically coupled thereto via the hydraulic extension cylinder. The second tubular leg surrounds and is fixedly secured to the outer casing of the hydraulic extension cylinder, and the first tubular leg is connected to the piston rod assembly thereof. Consequently, upon actuation of the hydraulic extension cylinder, the first and second tubular legs are displaced longitudinally relative to one another, thereby facilitating elevation of the attached load.

An optional third tubular leg member is telescopically received within the second tubular leg through a pull-pin casting that is secured to the lower end of the second leg. This third leg is freely adjustable longitudinally within the second tubular leg, and the pull-pin casting includes a spring-loaded locking pin configured to mate with any one of a plurality of openings in the side of the third tubular leg. As such, this third tubular leg constitutes a mechanically adjustable drop-leg assembly that may be freely adjusted and locked in any desired position relative to the second tubular leg. A foot or base plate is affixed to the bottom of the third leg for support of the jack assembly against a load-bearing surface, such as the ground. In the absence of the third leg, the base plate attaches to the bottom of the second leg.

The extension cylinder is comprised generally of an outer cylindrical casing within which an elongated piston rod assembly is housed for reciprocatory movement. A leg retraction mechanism, comprised of an elongated compression spring, is carried by the piston rod assembly within the piston extension cylinder. This compression spring is configured to slide over the piston rod in surrounding relation thereto, and is confined between the piston and the upper end cap of the extension cylinder.

Upon introduction of hydraulic fluid into the extension cylinder, the piston is caused to move upward within the extension cylinder, thereby simultaneously compressing the retraction spring as the hydraulically coupled legs of the jack assembly are extended. Upon release of the hydraulic fluid pressure, the force of the compression spring will cause the extension cylinder to automatically retract to its original position, drawing the first and second tubular legs back together.

By positioning a single compression spring over the piston rod in the above manner, retraction of the jack legs is accomplished swiftly and automatically with a minimum of required moving mechanical components. The maximum amount of energy from the compression spring is transferred directly in line with the piston rod assembly. Consequently, unlike conventional jack assemblies, the use of multiple extension springs to effect leg retraction has been eliminated. The compression spring utilized remains completely sealed within the extension cylinder, and there are no mechanical connections required to secure the ends of tension springs, as with conventional jack assemblies. This avoids the potential for localized structural damage at the spring joint connections due to metal fatigue from repeated cyclic loadings, as well as the potential for premature failure due to constant exposure to the elements of nature, such the sun, rain and snow, or dirt and gravel, etc.

### BRIEF DESCRIPTION OF THE DRAWINGS

These and other objects and advantages of the invention will more fully appear from the following description, made in connection with the accompanying drawings, wherein like reference characters refer to the same or similar parts throughout the several views, and in which:

FIG. 1 is a perspective view of a self-retracting hydraulic jack assembly constructed in accordance with the present invention;

FIG. 2 is a vertical sectional view of the hydraulic jack shown in FIG. 1;

FIG. 3 is a vertical sectional view of the extension cylinder for the hydraulic jack shown in FIG. 1;

FIG. 4 is a close-up sectional view of the piston for the extension cylinder of the hydraulic jack shown in FIG. 1; and

FIG. 5 is a top plan view of the pull-pin casting used for controlling the drop-leg assembly of the hydraulic jack shown in FIG. 1.

### DETAILED DESCRIPTION OF THE INVENTION

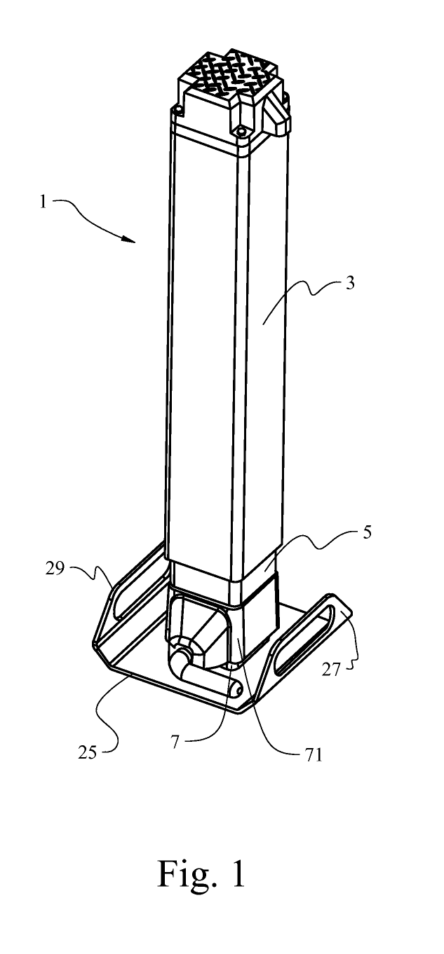

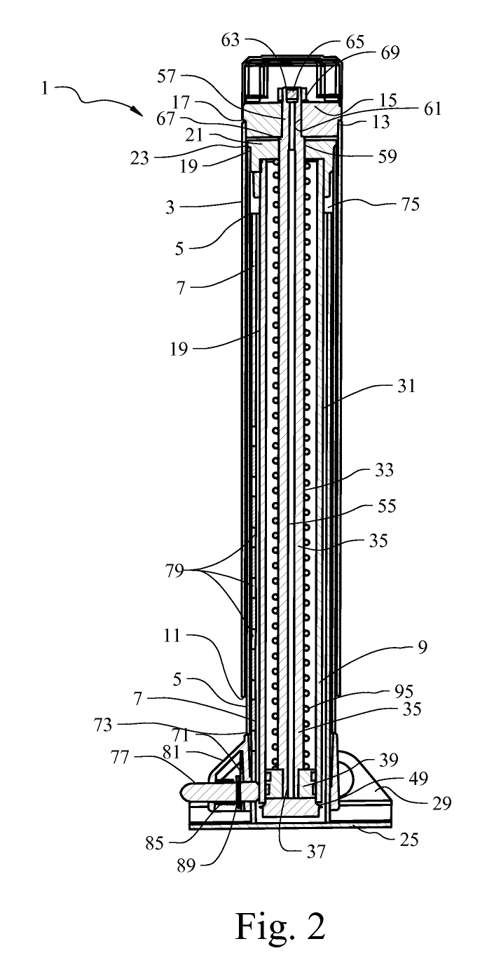

With reference to FIGS. 1 and 2, a hydraulic jack 1 configured in accordance with the present invention is shown. The hydraulic jack 1 is comprised generally of a plurality of telescoping tubular leg members 3, 5 and 7 that are extensible relative to one another in response to the introduction of hydraulic fluid into an extension cylinder 9. The first tubular leg member 3 constitutes the outer structural body of the jack assembly 1 and provides a mounting surface for attachment of the jack assembly 1 to the tongue of a trailer (not shown) or the like. This outer tubular leg 3 is open at its lower end 11 and includes an upper end 13 to which a bolster end cap 15 is secured. As shown in FIG. 2, the bolster cap 15 is received within the upper end 13 of the outer tubular leg 3 such that the upper end 13 of leg 3 seats against shoulder 17 of bolster cap 15. The bolster cap 15 is then welded to the outer tubular leg 3 at the joint therebetween adjacent shoulder 17.

As shown, the second tubular leg member 5 is constructed of slightly smaller dimensions and with the same cross-sectional configuration as the first tubular leg 3 such that it is capable of being telescopically received within leg 3 through the lower open end 11 thereof. This second tubular leg 5 surrounds the hydraulic extension cylinder 9, and is secured at its upper end 19 to the upper end cap 21 of the extension cylinder 9. As shown in FIG. 2, the upper end cap 21 of the extension cylinder 9 is received within the upper end 19 of the second tubular leg 5 such that the upper end 19 of leg 5 seats against shoulder 23 of end cap 21. The end cap 21 is welded to the second tubular leg 5 at the joint therebetween adjacent shoulder 23, thereby rigidly connecting leg 5 to the body of extension cylinder 9. The second tubular leg 5 is then slidably received within the first tubular leg 3 with the upper end cap 21 of the extension cylinder 9 disposed adjacent the bolster cap 15 of the first tubular leg 3.

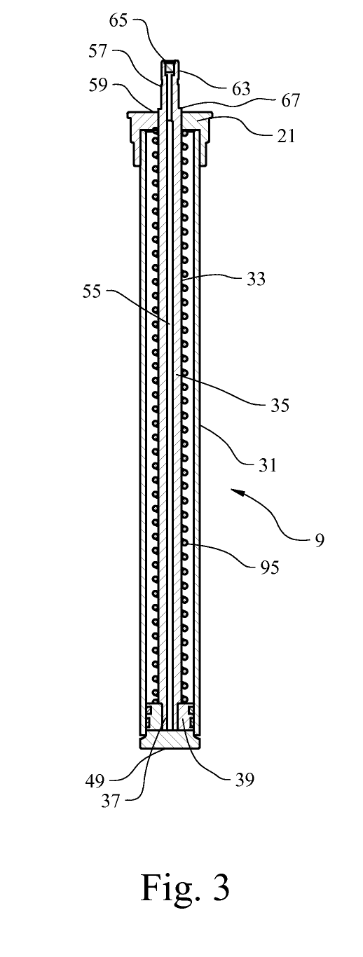

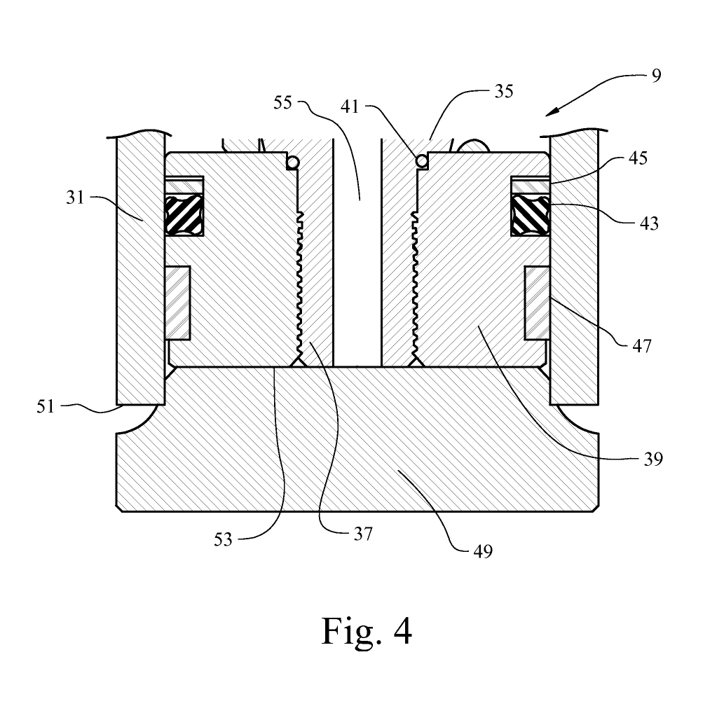

The first and second tubular leg members 3 and 5 of the jack assembly 1 are hydraulically coupled via extension cylinder 9 to affect extensible movement of one relative to the other. As shown best in FIG. 3, the extension cylinder 9 is comprised generally of an outer cylindrical casing 31 within which an elongated piston rod assembly 33 is housed for reciprocatory movement. The piston rod assembly 33 includes an elongated tubular piston rod 35 that extends the length of the cylindrical casing 31. As shown best in FIG. 4, piston rod 35 has a threaded lower male end 37 upon which a piston or ram 39 is threadably connected. The piston 39 includes an inner o-ring seal 41 for sealing against the body of the piston rod 35, and a main outer sealing ring 43 which forms a fluid seal with the inner diametrical surface of the outer casing 31 of extension cylinder 9. The main sealing ring 43 in FIG. 4 is illustrated in the form of a QUAD® brand seal, manufactured by Quadion Corporation, Minn., but it is certainly contemplated that other seals may be used for the same purpose of creating a fluid seal with the cylinder casing 31. As shown, in the present embodiment, the piston 39 also carries a backup sealing ring 45, and a wear ring 47 for preventing metal-to-metal abrasion of the piston 39 with cylinder casing 31. It has been found that with this piston construction and combination of seals, the hydraulic jack assembly 1 is capable of handling at least ten thousand pounds (10,000 lbs.) lift weight and twelve thousand pounds (12,000 lbs.) hold weight during use.

As shown further in FIG. 4, the outer casing 31 of the extension cylinder 9 is fluidly sealed at its lower end by a lower end cap 49. A portion of the lower end cap 49 is received within the lower end 51 of the cylinder casing 31 and the mating components are welded together to effectively seal the lower end of extension cylinder 9. With this construction, a hydraulic fluid storage chamber 53 is formed between the piston 39 and the lower end cap 49 of extension cylinder 9.

As seen best in FIGS. 2 through 4, the piston rod 35, being tubular in nature, has a central orifice 55 extending lengthwise through its body through which hydraulic fluid may flow to and from the hydraulic fluid storage chamber 53. The lower end 37 of the piston rod 35 extends completely through the piston 39 and is in fluid communication with the hydraulic fluid storage chamber 53 of extension cylinder 9. The upper end portion 57 of the piston rod 35 extends through a central opening 59 in the upper end cap 21 of extension cylinder 9 and through a central opening 61 in the bolster cap 15 of outer tubular leg 3. The upper terminal end 63 of the piston rod forms a hydraulic fluid coupling 65 that is connectable to and integrates with a hydraulic power supply (not shown). Consequently, the piston rod 35 acts as a conduit for the passage of hydraulic fluid to and from the hydraulic fluid storage chamber 53 of extension cylinder 9.

The upper portion 57 of piston rod 35 is fixedly secured to the bolster cap 15 of the first outer leg 3. As shown best in FIG. 2, the top portion 57 of the piston rod 35 is slightly reduced in diameter to create a shoulder or stop 67 which prevents the piston rod 35 from sliding through the bolster cap 15. The upper terminal end 63 of the piston rod is then threaded to receive a complimentary nut 69 which fixedly secures the bolster cap 15 to the upper end of piston rod 35. In this manner, any movement of the piston rod assembly 33 within the extension cylinder 9 will cause the outer tubular leg 3 to move longitudinally relative to the second tubular leg 5.

More specifically, hydraulic fluid introduced into the extension cylinder 9 through the piston rod 35 will flow into the hydraulic fluid storage chamber 53, thereby increasing fluid pressure and causing the piston rod assembly 33 to move upwardly within the extension cylinder 9. With the first tubular leg 3 fixedly secured to the piston rod 35 and the second tubular leg 5 rigidly connected to the outer casing 31 of the extension cylinder 9, such movement of the piston rod assembly 33 within extension cylinder 9 in response to the introduction of hydraulic fluid will cause the first and second tubular members 3 and 5 to extend longitudinally relative to one another.

As shown in FIG. 2, the second leg 5, in turn, is designed to telescopically receive an optional third tubular leg member 7 of the jack assembly 1. A tubular pull-pin casting 71 having a cross-sectional configuration substantially matching that of leg 5 is welded to the lower end 73 of the second leg 5. The function of this pull-pin casting 71 will be described in more detail hereafter, but as shown, leg 7 is constructed to telescope through the pull-pin casting 71 and into a guide channel 75 formed between the second tubular leg 5 and the outer casing 31 of extension cylinder 9. This third leg 7 is therefore constitutes a manual drop-leg assembly that is freely adjustable longitudinally within the second tubular leg 5. As shown in FIGS. 1 and 2, leg 7 includes a base plate or foot member 25 attached to its lower terminal end which provides a relatively broad load-bearing surface upon which the jack assembly 1 and attached load (i.e., trailer) is supported when the jack assembly is actuated. Side handles 27 and 29 are provided on the foot member 25 to aid the operator in sliding leg 7 into leg 5, as necessary. In the absence of leg 7, the base plate 25 connects directly to the lower end of tubular member 5.

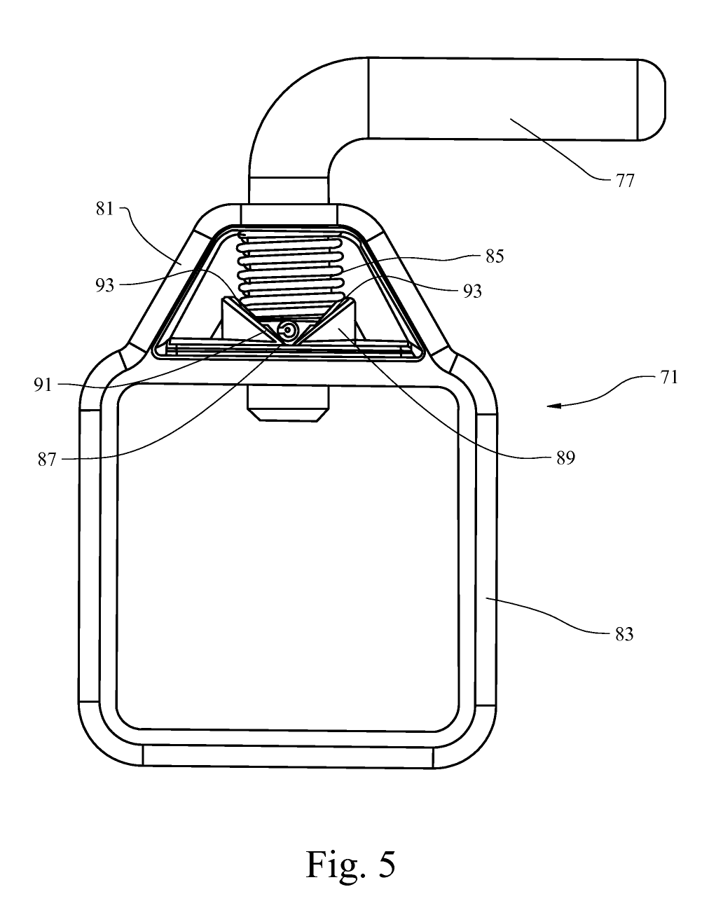

The function of pull pin casting 71 is best illustrated with reference to FIGS. 2 and 5. As shown, the pull-pin casting 71 includes a spring-loaded locking pin 77 configured to mate with any one of a plurality of openings 79 formed in the side of the third tubular leg 7. As such, the third tubular leg 7 of the jack assembly 1 constitutes a mechanically adjustable “drop-leg” assembly that may be freely adjusted and locked in any desired position relative to the second tubular leg 5. As shown best in FIG. 5, the spring-loaded locking pin 77 extends through a latch spring housing 81 of the pull-pin casting 71 and into the main housing 83 thereof, where it may engage the “drop leg” assembly 7. A compression latch spring 85 is carried by the locking pin 77 within the spring housing 81. As shown, latch spring 85 is confined on one end by the body of spring housing 81 and on the other end by a roll pin 87 extending through locking pin 77.

In FIG. 5, the roll pin 87 is illustrated in its seated position within the cradle 91 of a generally V-shaped pull-pin cam 89. Thus, by merely rotating locking pin 77 in either direction, the roll pin 87 is caused to travel up one of the ramped surfaces 93 of the pull-pin cam 89, thereby automatically pulling the locking pin 77 out of the main housing 83 of the pull pin casting 71, and out of locking engagement with the “drop-leg” assembly 7. Such rotation of the locking pin 77 simultaneously causes the latch spring 85 to compress and, upon continued rotation of locking pin 77, the force of latch spring 85 will cause the roll pin 87 to travel down the opposite slope 93 of cam 89 and back into the cradle 91 thereof, where the locking pin 77 may once again move into locking engagement with any one of the openings 79 in the drop-leg assembly 7. As is evident from the above, rotation of the locking pin 77 in ninety degree (90°) intervals will tend to move the locking pin 77 into and out of position for locking engagement with the leg 7 of the jack assembly 1.

In operation, when it is desired to decouple a trailer or similar device upon which jack assembly 1 is mounted from a towing vehicle, turning the locking pin 77 either clockwise or counterclockwise will cause the pin 77 to back out of its engaged opening 79 in leg 7. This causes leg 7 to become disengaged from leg 5 and drop to or near ground level, where it is then re-engaged in locking relation with leg 7. Extension cylinder 9 may then be actuated, causing hydraulic fluid to be pumped into the hydraulic storage chamber 53 thereof. This causes piston rod assembly 33 to move and leg 5 to extend relative to outer leg 3. In turn, foot 25 of leg 7 will engage the ground and the jack assembly 1 will raise the trailer, thereby decoupling it from the towing vehicle.

Upon release of hydraulic pressure within the jack assembly 1, it is desirable for the first and second tubular leg members 3 and 5 to retract to there original positions relative to one another. In order to cause legs 3 and 5 to retract, a leg retraction mechanism, comprised of an elongated compression spring 95, is carried by the piston rod assembly 33 within the extension cylinder 9. This compression spring 95 is configured to slide over the piston rod 35 in surrounding relation thereto, so as to be confined between the piston 39 and the upper end cap 21 of the extension cylinder 9. With this configuration, introduction of hydraulic fluid into the extension cylinder 9 will cause the piston 39 to move upward toward the end cap 21, thereby compressing the retraction spring 95 at the same time. Upon release of the hydraulic fluid pressure, the force of the compression spring 95 will cause the extension cylinder 9 to automatically retract to its original unextended position, thereby drawing the first and second tubular legs 3 and 5 back together.

By positioning a single compression spring 95 over the piston rod 35 in the above manner, retraction of legs 3 and 5 of the jack assembly 1 is accomplished swiftly and automatically with a minimum of required moving mechanical components. The maximum amount of energy from the compression spring 95 is transferred directly in line with the piston rod assembly 33. Consequently, unlike conventional jack assemblies, the use of multiple extension springs to effect leg retraction has been eliminated. The compression spring 95 utilized remains completely sealed within the extension cylinder 9, and there are no mechanical connections required to secure the spring ends to effect proper operation, as with conventional tension springs. Therefore, the spring 95 is free-floating within cylinder casing 31 of extension cylinder 9. As noted previously, this avoids the potential for localized structural damage at the spring joint connections due to metal fatigue from repeated cyclic loadings, as well as the potential for premature failure due to constant exposure to the elements of nature, such the sun, rain and snow, or dirt and gravel, etc.

In the illustrated embodiment herein, the telescoping tubular members 3, 5 and 7 are depicted as being square in cross section, which facilitates convenient mounting of the jack assembly 1 in multiple optional orientations upon a trailer or the like. However, it is certainly contemplated that such telescoping members could be configured differently without departing from the invention herein. For instance, the tubular leg members 3, 5 and 7 could be rectangular or circular in cross section, and still provide maximum flexibility, since the retraction compression spring 95 is sealed within the extension cylinder 9 and does not obstruct in any manner the outer mounting surface of tubular member 3.

Certain terminology used herein is for purposes of reference only, and is not intended to be limiting in any manner. For instance, terms such as “upper”, “lower”, “above”, “below”, “top”, “bottom”, “upward”, “downward”, “rearward”, and “forward” may refer to directions in the drawings to which reference is made. Similarly, terms such as “front”, “back”, “rear”, “bottom” and “side”, may describe the orientation of portions of the component within a consistent but arbitrary frame of reference which is made clear by reference to the text and the associated drawings describing the component under discussion. Such terminology may include the words specifically mentioned above, derivatives thereof, and/or words of similar import. Also, the terms “first”, “second” and other such numerical terms referring to structures do not imply a sequence or order unless clearly indicated by the context.

Furthermore, when introducing elements or features and the exemplary embodiments, the articles “a”, “an”, “the” and “said” are intended to mean that there are one or more of such elements or features. The terms “comprising”, “including” and “having” are intended to be inclusive and mean that there may be additional elements or features other than those specifically noted. It should be further understood that the method steps, processes, and operations described herein are not to be construed as necessarily requiring their performance in the particular order discussed or illustrated, unless specifically identified as an order of performance. It is also to be understood that additional or alternative steps may be employed.

It will, of course, be understood that various changes may be made in the form, details, arrangement and proportions of the parts without departing from the scope of the invention which comprises the matter shown and described herein and set forth in the appended claims.

1. A self-retracting hydraulic jack, comprising:
a hydraulic cylinder casing having an axially extending bore;
a piston carried within said bore of said cylinder casing and operably moveable therein by fluid pressure;
a piston rod secured to said piston and being movable with said piston between a retracted position and an extended position relative to said cylinder casing; and
a free-floating spring member carried within said cylinder casing, said spring member engaging and biasing said piston toward said retracted position.

2. The self-retracting hydraulic jack defined in claim 1, wherein said spring member is comprised of a compression spring which is compressed upon movement of said piston rod toward said extended position.

3. The self-retracting hydraulic jack defined in claim 1, wherein said spring member is comprised of a single coil spring which telescopes said piston rod.

4. The self-retracting hydraulic jack defined in claim 1, wherein said spring member has a biasing force that is directed substantially parallel with said axis of said bore.

5. The self-retracting hydraulic jack defined in claim 4, wherein said biasing force of said spring member is directed generally coaxially with said piston within said bore.

6. The self-retracting hydraulic jack defined in claim 1, wherein said spring member is comprised of an unattached compression spring which extends axially within said cylinder casing in encircling relation to said piston rod.

7. The self-retracting hydraulic jack defined in claim 1, wherein said piston rod is comprised of a conduit for the introduction of said fluid pressure to said hydraulic cylinder casing.

8. The self-retracting hydraulic jack defined in claim 7, wherein said piston rod is comprised of a tubular member through which hydraulic fluid may pass.

9. The self-retracting hydraulic jack defined in claim 1, wherein said piston rod is comprised of a tubular member which extends through said piston.

10. The self-retracting hydraulic jack defined in claim 1, including a tubular leg member connected to said piston rod in telescoping relation to said cylinder casing.

11. A self-retracting hydraulic jack, comprising:
a hydraulic cylinder casing having an axially extending bore;
a piston carried within said bore of said cylinder casing and operably moveable therein by fluid pressure;
a piston rod secured to said piston and being movable with said piston between a retracted position and an extended position relative to said cylinder casing, said piston rod providing a conduit for the introduction of hydraulic fluid to said cylinder casing; and
a spring member carried within said cylinder casing, said spring member being positioned to bias said piston rod toward said retracted position.

12. The self-retracting hydraulic jack defined in claim 11, wherein said spring member is free-floating within said cylinder casing.

13. The self-retracting hydraulic jack defined in claim 11, wherein said spring member is comprised of an unattached compression spring which surrounds said piston rod in telescoping relation.

14. The self-retracting hydraulic jack defined in claim 11, wherein said piston rod is comprised of a tubular member having opposite ends, one of said ends of which extends through said piston in sealed relation thereto.

15. The self-retracting hydraulic jack defined in claim 11, including an exterior tubular leg member connected to said piston rod and telescoping over said cylinder casing.

16. The self-retracting hydraulic jack defined in claim 15, including a freely adjustable inner tubular leg member telescopically received in sliding relation within said exterior tubular leg member.

17. The self-retracting hydraulic jack defined in claim 16, wherein said inner tubular leg member is slidably received between said cylinder casing and said exterior tubular leg member.

18. The self-retracting hydraulic jack defined in claim 16, including a cam-actuated locking mechanism for adjustment of said inner tubular leg member.

19. A self-retracting hydraulic jack, comprising:
a hydraulic cylinder casing having an axially extending bore;
a piston carried within said bore of said cylinder casing and operably moveable therein by fluid pressure;
a piston rod secured to said piston and being movable with said piston between a retracted position and an extended position relative to said cylinder casing, said piston rod providing a conduit for the introduction of hydraulic fluid to said cylinder casing;
a spring member carried within said cylinder casing, said spring member being positioned to bias said piston rod toward said retracted position;
an exterior tubular leg member connected to said piston rod and telescoping over said cylinder casing;
an adjustable inner tubular leg member telescopically received in sliding relation between said cylinder casing and said exterior tubular leg member; and
a cam-actuated locking mechanism for adjustment of said inner tubular leg member relative to said cylinder casing.

20. The self-retracting hydraulic jack defined in claim 19, wherein said spring member is comprised of a compression coil spring which surrounds said piston rod in free-floating telescoping relation.

21. The self-retracting hydraulic jack defined in claim 19, wherein said piston rod is comprised of a tubular member having opposite ends, one of said ends of which extends through said piston in sealed relation thereto.
